(19) United States
(12) Patent Application Publication
(10) Pub. No.: US 2001/0039493 A1
(43) Pub. Date: Nov. 8, 2001

(54) Answering verbal questions using a natural language system

(76) Inventors: James D. Pustejovsky, Arlington, MA (US); Robert J. P. Ingria, Somerville, MA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/742,813

(22) Filed: Dec. 19, 2000

Related U.S. Application Data
(60) Provisional application No. 60/197,011, filed on Apr. 13, 2000.

(51) Int. Cl. G10L 15/26; G10L 21/00; G10L 15/00

(52) U.S. Cl. 704/235; 704/270.1

(57) ABSTRACT

According to the present invention, a technique including a method and system for managing information is provided. In an exemplary embodiment a method and a system is provided for answering voice questions using a remote mobile device, e.g., cell phone, by a natural language system.

### CROSS-REFERENCES TO RELATED APPLICATIONS

This application claims priority from the following provisional patent application, the disclosure of which is herein incorporated by reference for all purposes:

U.S. Provisional patent application Ser. No. 60/197,011 in the names of James D. Pustejovsky titled, “Answering Verbal Questions Using A Natural Language System,” filed Apr. 13, 2000.

The following commonly owned previously filed applications are hereby incorporated by reference in their entirety for all purposes:

U.S. patent application Ser. No. 09/449,845 in the names of James D. Pustejovsky, et al. titled, “A Natural Knowledge Acquisition System,”, filed Nov. 26, 1999;

U.S. patent application Ser. No. 09/433,630 in the names of James D. Pustejovsky, et al. titled, “A Natural Knowledge Acquisition Method,” filed Nov. 26, 1999;

U.S. patent application Ser. No. 09/449,848 in the names of James D. Pustejovsky, et al. titled, “A Natural Knowledge Acquisition System Computer Code,” filed Nov. 26, 1999;

U.S. Provisional patent application Ser. No. 60/163,345 in the names of James D. Pustejovsky, et al. titled,“A Method For Using A Knowledge Acquisition System,” filed Nov. 3, 1999; and

U.S. Provisional patent application Ser. No. 60/191,883 in the names of James D. Pustejovsky, titled,“Returning Dynamic Categories in Search and Question-Answer Systems,” filed Mar. 23, 2000.

U.S. Provisional patent application Ser. No. ______ in the names of James D. Pustejovsky, et. al, titled,“Type Construction And The Logic Of Concepts,” filed Aug. 18, 2000 (Attorney Docket No. 019497-002200).

U.S. Provisional patent application Ser. No. _______ in the names of James D. Pustejovsky, et. al, titled, “Answering User Queries Using a Natural Language Method and System,” filed Aug. 28, 2000 (Attorney Docket No. 019497-000150US).

### BACKGROUND OF THE INVENTION

This invention generally relates to the field of information management. More particularly, the present invention provides a method and system for natural language processing of voice over a communications network.

The expansion of the Internet has proliferated “on-line” textual information. Such on-line textual information includes newspapers, magazines, WebPages, email, advertisements, commercial publications, and the like in electronic form. By way of the Internet, millions if not billions of pieces of information can be accessed using simple “browser” programs. Information retrieval (herein “IR”) engines such as those made by companies such as Yahoo! Inc. allow a user to access such information using an indexing technique. The indexing technique includes full-text indexing, in which content words in a document are used as keywords. Unfortunately, full text searching has many limitations. For example, full text searching lacks precision and often retrieves literally thousands of “hits” or related documents, which then require further refinement and filtering. This is because the information retrieval search engines, the results of the queries are “hits” rather than “answers”; that is, a hit is the entire text that matches the indexing criteria, while an answer on the other hand is the actual utterance (or portion of the text) that satisfied a user query. For example, if the query were “Who are the officers of Microsoft Corporation?”, a hit-based system would return all the documents that contain this information anywhere within them, whereas an answer-based system would return the actual value of the answer, namely the officers. This would be true for either a local database query or a query over the Internet (e.g., using Inktomi or Alta Vista). Accordingly, full text searching has much room for improvement.

Along with the rapid expansion of the Internet, there has been a great expansion in the use of mobile communications. For example, the cell phone is as readily found on a farmer in Kansas as a New York City businessman. Conventionally, to retrieve information using a cell phone or a telephone, a simple voice recognition system is used, which may ask “What city?” (a keyword search) and usually results in being connected to a human operator. The user asks her question in a natural language format, e.g., “Where is the Sunnyvale Pizza Hut?” and the operator may look-up the answer on a database or a Web page on the Internet and respond with an answer. Efficiency would be greatly improved, if the user could get her answer directly from the database or Internet without going through a human.

With the recent improvements in speech recognition, the voice to text transformation may have better performance, but the use of this textual information to get a useful result still needs a human operator or customer service representative as an intermediary to access the database or Internet containing the information. This is because, as explained above, the typical IR search engine uses keywords and needs a human both as pre and post filter.

From the above, it is seen that a technique for automated answers to a user's natural language question over a remote device, for example a verbal query over a remote device is highly desirable.

### SUMMARY OF THE INVENTION

According to the present invention, a technique including a method and system for managing information is provided. In an exemplary embodiment a method and a system is provided for answering voice questions using a remote device by a natural language system.

In a specific embodiment, the present invention provides a method for responding to a question sent by a remote user to a natural language system via a communications network. The natural language system receives a verbal question from the remote user and transforms the verbal question into a textual format. In another embodiment the voice to text transformation is done at a service provider system and the text forwarded to the natural language system. The natural language system then processes the textual format using a natural language system, which includes in one embodiment, a type structure, and returns an answer to the user. Where the type structure may include a qualia. The answer may be a textual or a voice response. In an embodiment the remote user uses a remote device, for example, a cell phone, a Personal Digital Assistant (PDA), telephone, computer, cable TV, or net-phone, to send the query to the natural language system and to receive the answer.

In another embodiment a method for dynamic categories in an information retrieval system, is provided including: receiving either a voice or text query from a user remote device; searching for information in response to said query by the natural language system; and returning relevant information organized into a plurality of related categories based on content of the query. In one embodiment the information may be stored at the natural language system and only the related categories displayed or given by voice at the remote user device. The user may select by voice or keypad a particular related category and listen to the contents of the category or the contents may be shown on a cellular phone display.

In yet another embodiment a natural language question and answer system for receiving a query from a remote user over a communications network and returning a result to the remote user is provided. The system includes: a cellular telephone for receiving the query from the remote user; and a computer system connected to the cellular telephone by the communications network for processing the question. The computer system includes: a database comprising information to respond to the question; and natural language software for analyzing the query and determining an answer using the database.

One of the many advantages over prior art is increasing the probability that the user's query is correctly answered. Another is using a remote device to ask and receive answers verbally using a natural language processing system.

### BRIEF DESCRIPTION OF THE DRAWINGS

FIG. 1 illustrates a simplified network architecture of a specific embodiment of the present invention; and

FIG. 2 shows a simplified flowchart for a specific embodiment of the present invention.

### DESCRIPTION OF THE SPECIFIC EMBODIMENTS

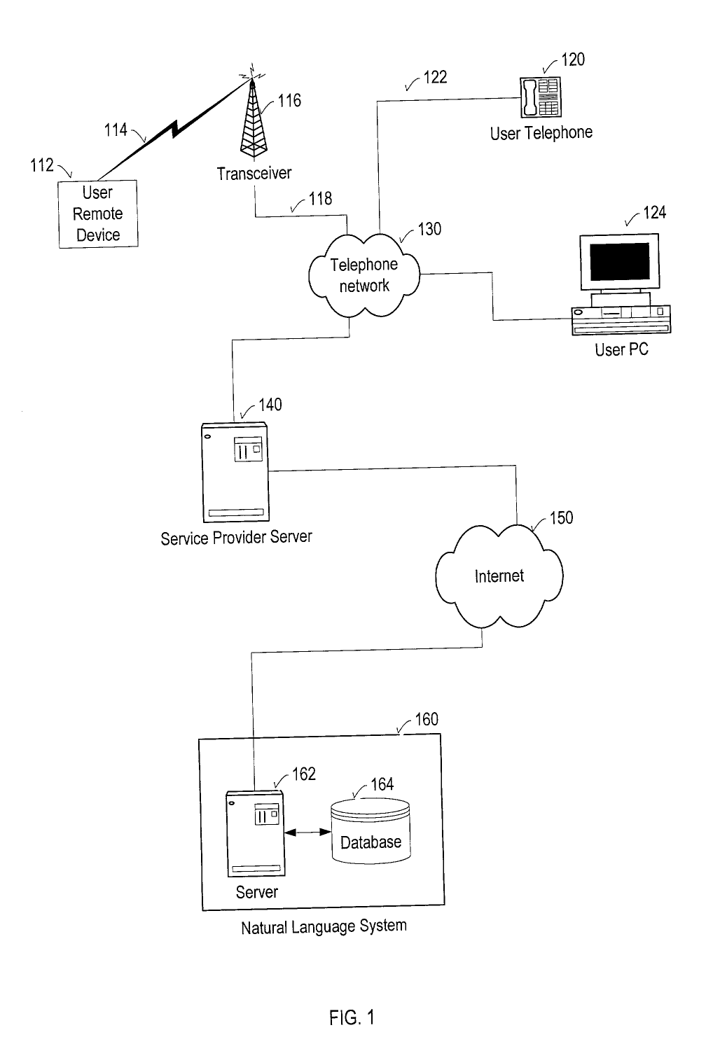

FIG. 1 illustrates a simplified network architecture of a specific embodiment of the present invention. A user may carry a mobile remote user device 112, for example, a cell phone, laptop computer, Personal Digital Assistant (PDA), in which the user inputs a verbal or textual question. The user remote device 112 communicates via a wireless link 114 to a transceiver 116. The transceiver 116 is connected by landline 118 to a telephone switching network 130. In an alternative embodiment the connection 118 may be a wireless connection, the telephone network 130 a wireless network or a typical landline telephone network or a combination thereof, and the transceiver 116 one station in a wireless network. In other embodiments a user telephone 120 or user PC 124 or laptop are connected to the telephone network 130. The user may ask a question over a typical telephone. Or the user may ask a question over an Internet telephone using the user's PC 124 and e.g., Net2Phone, Inc., of Hackensack, N.J., software.

The user device 112, 120, 124, is connected via the telephone network 130 to a Service Provider Server 140, which includes a processor and a memory. The Service Provider Server 140 provides a voice to text conversion and access to the Internet 150. In an alternative embodiment the voice to text transformation is accomplished at the user device, 112, 120, or 124 and text is sent to the Service Provider Server 140. Commercial software, for example, Dragon NaturallySpeaking® from Dragon Systems of Newton, Mass. or IBM's ViaVoice for Mac, may be used to convert a verbal question into its textual form. Another embodiment would first use a speech recognition system and if errors occurred, have human intervention covert the verbal question to text. The Service Provider Server 140 would then forward the question in text form to the Natural Language System 160 via the Internet 150. The Natural Language System 160 includes a server 162 and a database 164 and is described in U.S. patent application Ser. No. 09/449,845 in the names of James D. Pustejovsky, et al. titled, “A Natural Knowledge Acquisition System,”, filed Nov. 26, 1999, which is herein incorporated by reference in its entirety.

In a specific embodiment, the natural language processing system 160 includes a software engine running on a computer server 162. The engine includes a tokenizer, which is adapted to receive a stream of text information and separates the stream of text information into a plurality of tokens. The engine also includes a tagger coupled to the tokenizer that is adapted to tag each token. A stemmer coupled to the tagger also is included. The stemmer is adapted to stem each of the tagged tokens. The interpreter is coupled to the stemmer. The interpreter is adapted to form an object including syntactic information and semantic information from each of the stemmed, tagged, tokens.

The system 160 has a relational or objected oriented or mixed database 164, e.g., coupled to the engine on the server 162. The engine is adapted to form a knowledge base from a stream of text information. The knowledge base has a plurality objects that populate the database 164. The engine is adapted to retrieve from the knowledge base an answer to a query by the user.

In another specific embodiment of the present invention a list of relevant documents in response to a user query is returned. These documents may be ranked according to relevance, but more importantly, categorized dynamically into relevant classifications and sub-classifications, as motivated (or directed) by the content of a query. These “related or dynamic categories” allow for a more natural and intuitive navigability of the document set returned by a query than conventional search technologies allow. The related categories are not static or pre-defined labels assigned to documents, but are computed dynamically as the result of two steps:

1. The documents are processed by the natural language processing system 160 (see U.S. patent application Ser. No. 09/449,845 in the names of James D. Pustejovsky, et al. titled, “A Natural Knowledge Acquisition System,”) and relevant entities and relations are stored in the database 164.

2. The query is processed by the natural language processing system 160 and the entities and relations are represented in a normalized logical form.

The semantic form (normalized logical form) for the query is matched against the database; both exact matches (if present) and dynamically computed related categories are returned. A further description is given in U.S. Provisional patent application Ser. No. 60/163,345 in the names of James D. Pustejovsky, et al. titled,“A Method For Using A Knowledge Acquisition System,” filed Nov. 3, 1999; and U.S. Provisional patent application Ser. No. ______ in the names of James D. Pustejovsky, titled,“Returning Dynamic Categories in Search and Question-Answer Systems,” filed Mar. 23, 2000, (Attorney Docket No. 019497-001700US), which are herein incorporated by reference.

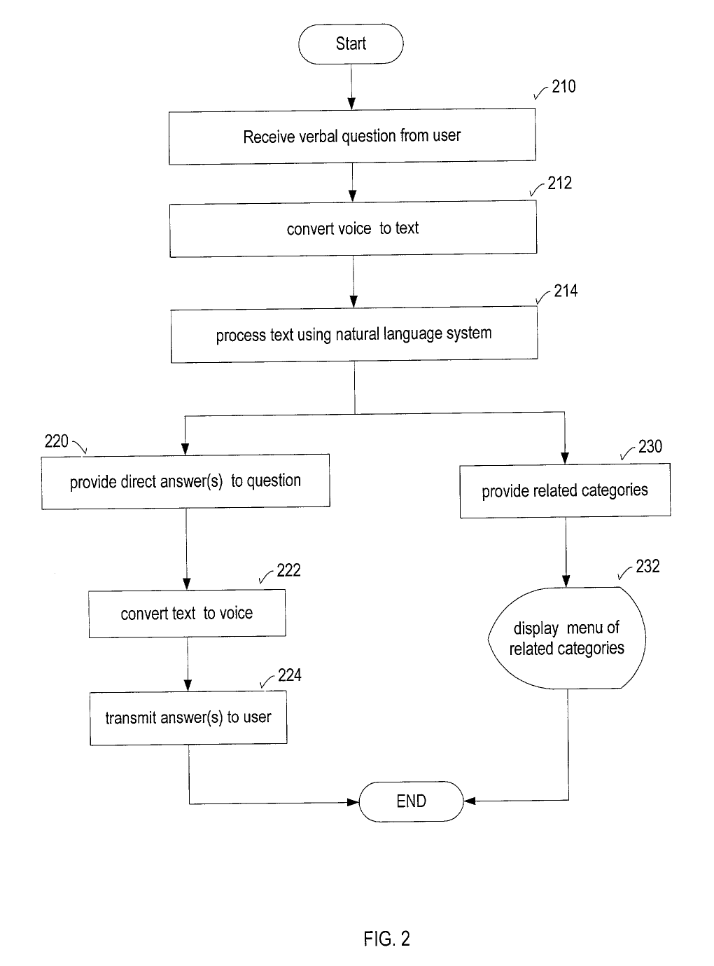

FIG. 2 shows a simplified flowchart for a specific embodiment of the present invention. At step 210 the user remote device 112, user telephone 120, or user PC 124 receives a verbal question from the user. This is sent to a Service Provider Server 140 via telephone network 130, were the verbal query is converted to its textual form (step 212). The textual query is sent via the Internet 150 to the natural language system 160 were the query is processed (step 214). Two different forms of answers are provided by the natural language system 160: direct answer(s) to the query (step 220) and related categories to the query (step 230). The direct answer(s), step 220, are sent to the Service Provider Server 140 via the Internet 150 were they are converted from text to voice, step 222, using, for example, a Lucent Speech Solutions of Murray Hill, NJ multilingual text-to-speech (TTS) product (see www.bell-labs.com/project/tts). The synthesized verbal answer(s) is then sent back to the user at, for example, user remote device 112 via telephone network 130. In another embodiment the answer(s) may be displayed on, for example, a cell phones LCD display. If related categories (step 230) are provided, then they may be sent in textual form from the Service Provider Server 140 to, for example, a user remote device 112, such as a cell phone, pager, or Palm Pilot, via the telephone network 130. And displayed on the remote device 112 (step 232), for example, the LCD display of a Samsung SCH-8500 or Motorola Timeport P8167 cell phone. The user could then select to view sub-categories or documents using for example the keypad on the cell phone. In another embodiment, at step 232, the related categories may be given in verbal rather than textual form and the user may select a sub-category or document via verbal command and have, for example, the document read to her.

The following example illustrates how the user may use one embodiment of the present invention. The user over her cell phone, 112, would ask the Service Provider Server 140: “What did the S&P stock index do?.” This verbal question would be converted into its textual form, i.e., “What did the S&P stock index do?,” and sent to the natural language system 160. This textual query would go through the stages including tagging and tokenization to yield:

What/WP did/VBD the/DT S&P500/NNP stock/NN index/NN do/VB?/. and would produce a semantic representation of the following form:

[UtteranceLexLF
type: [[Question]]
illocutionaryForce: #WhQuestion
content: [FunctionLexLF

type: [[QueryDo]]
predicateStem: ‘do’
complements: (#Subject −> [EntityLexLF

type: [[Abstract Object]]
value: ‘S&P500 stock index’
quantification: [QuantifierLexLF

type: [[Abstract Object]]
value: ‘The’]]

#DirectObject −> [EntityLexLF

type: [[Entity]]
value: ‘What’
quantification: [QuantifierLexLF

type: [[Entity]]
value: ‘what’
quantifier: #Wh]])]]

There are several features of this semantic form. First, the semantics of the interrogative pronoun ‘What’ is interpreted in its ‘logical’ position, i.e. as the direct object of the main verb ‘do’. Second, the semantic representation of ‘What’ includes a QuantifierLexLF that has #Wh as the value of its #quantifier. This indicates that this is the logical argument that is being asked about in this query.

Semantic representations for content queries of this type are processed for database 164 lookup in the following manner: First, the EntityID of the subject is retrieved:

select EntityID from Entities where CanonicalName=‘S&P500 stock index’

This will retrieve the EntityID 5230, which is then used to construct a select statement on the Relations table:

select * from Relations where Subject=5230

This will retrieve the row:

(776,23,405,380,5230,null, 5231,‘36.46’,0,0,null,0,null,0,null,0)

Finally, for presentation to the user, the system will use this information to retrieve the sentence:

The S&P500 stock index rose 36.46 points;

i.e. the sentence at offset position 380, in the document with DocumentID 405, whose filename is ‘0000077400’. This information is passed to the server 162 in the format:

<DISPLAY-FULL-OBJECT””
{ “Reuters”
“http://199.103.231.59/demo-

code/source.pl/display=0000077400,380#380”

“The S&P500 stock index rose 36.46 points.”} {} >

which contains the source of the response text, a URL that points to the complete source document, and the actual response text.

The Natural Language System Server 162 may retrieve the complete source document of the given URL and pass both the answer to the query (“What did the S&P stock index do?”), i.e., “The S&P500 stock index rose 36.46 points,” as well the complete source document text to the Service Provider Server 140. The Service Provider Server 140 would then covert the answer from text to voice and the user would hear on his cell phone 112: “The S&P500 stock index rose 36.46 points. If you want to hear the complete source of the answer, press #.” If the user presses “#,” the Service Provider Server 140 would then covert the source text to voice and send it to the user's cell phone 112.

The above embodiments illustrate an embodiment of a natural language system that may be used in responding to voice from a remote user, for example a cell phone customer, a PDA user with a wireless connection, an Internet telephone user, a landline telephone user, or the like. Other embodiments of natural language systems that may be used in the present invention are described in U.S. Pat. No. 5,794,050 in the names of Dahlgren et al., LexiGuide products, e.g., Web or Surfer or Expert, of LexiQuest, Inc, Ask Jeeves, Inc. question and answering product, vReps of Neuromedia, Inc., ALife-SmartEngine of Artificial Life, Inc., and the like.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. For example, a voice query could be for directions to the closest Italian Restaurant or the nearest Hospital which accepts Blue Cross Insurance. Therefore, it is to be understood that within the scope of the appended claims, the invention may be practiced otherwise than as specifically described.

What is claimed is:

1. A method for responding to a verbal question sent by a remote user to a natural language system via a communications network, comprising:
receiving the verbal question from the remote user;
transforming the verbal question into a textual format;
processing the textual format using a natural language system; and
returning an answer to the user.

2. The method of claim 1 wherein the communications network comprises a cellular telephone for receiving the verbal question from the remote user.

3. The method of claim 1 wherein the natural language system comprises a type structure.

4. The method of claim 3 wherein the type structure includes a qualia.

5. A method for obtaining an answer to a verbal question from a natural language system by a user using a remote device comprising:
sending the verbal question by the remote device to a service provider system via a communications network; and
receiving the answer from the service provider system after the answer to the verbal question is determined by the natural language system.

6. The method of claim 5 wherein the natural language system comprises a type structure.

7. The method of claim 5 wherein the remote user uses a remote device selected from a group consisting of a radio, a transceiver, a cell phone, a mobile phone, a Personal Digital Assistant (PDA), a telephone, a computer, an interactive TV, or an Internet phone.

8. A method for responding to a verbal question sent by a remote user to a natural language system via a communications network, comprising:
receiving a verbal question from the remote user;
converting the verbal question to a text question;
processing said text question using the natural language system; and
returning to the remote user a plurality of related categories generated by the natural language system.

9. The method of claim 8, wherein the user verbally selects a related category.

10. A natural language question and answer system for receiving a query from a remote user over a communications network and returning a result to the remote user, comprising:
a cellular telephone for receiving the query from the remote user; and
a computer system connected to the cellular telephone by the communications network for processing the question, wherein the computer system comprises:
a database comprising information to respond to the question; and
natural language software for analyzing the query and determining an answer using the database.

11. The system of claim 10 wherein the information comprises type information.

12. The system of claim 10 wherein the answer includes related category information.

13. A natural language system for responding to a verbal question sent by a remote user via a communications network, said system including a memory comprising:
code directed to receiving the verbal question from the remote user;
code directed to transforming the verbal question into a textual format;
code directed to processing the textual format using a natural language system; and
code directed to returning a result to the user.

14. The system of claim 13 further comprising code representing type information.
